(19) United States
(12) Patent Application Publication
(10) Pub. No.: US 2026/0251849 A1
(43) Pub. Date: Aug. 27, 2026

(54) ADAPTIVE CABLE ASSEMBLY AND METHOD FOR CONSTRUCTION

(71) Applicant: AFL Telecommunications LLC, Duncan, SC (US)

(72) Inventors: Asher Leong Raven, Milton Keynes (GB); Aran James Russell Davidson, Chesham (GB); Keith Sullivan, Kent (GB); Alan Keizer, Bucks (GB)

(21) Appl. No.: 18/994,407

(22) PCT Filed: Apr. 28, 2023
(86) PCT No.: PCT/US2023/020324

§ 371 Date: Jan. 14, 2025

Related U.S. Application Data
(60) Provisional application No. 63/389,639, filed on Jul. 15, 2022.

(51) Int. Cl. G02B 6/255; G02B 6/44

(52) U.S. Cl. CPC G02B 6/2551; G02B 6/2558; G02B 6/443; G02B 6/44715; G02B 6/44765

(57) ABSTRACT

An adaptive cable assembly and a method for construction thereof is provided. The method includes mass fusion splicing optical fibers at a cable with optical fibers at a connectorized fiber optic tail assembly, and positioning the mass fusion splice in a cavity extending along a longitudinal axis formed by a body extending along the longitudinal axis. The body forms a first open end along the longitudinal axis through which the connectorized fiber optic tail assembly is extended when the mass fusion splice is positioned in the cavity. The body forms a second open end along the longitudinal axis through which the fiber optic cable is extended when the mass fusion splice is positioned in the cavity.

### PRIORITY STATEMENT

The present application claims the benefit of priority to U.S. provisional patent application Ser. No. 63/389,639, filed on Jul. 15, 2022, the disclosure of which is incorporated by reference herein in its entirety.

### FIELD

The present disclosure relates generally to fiber optic cable assemblies and assembly processes, and more particularly to improved cable assemblies and assembly processes which support rapid and low labor final assembly of moderate to high fiber count cable assemblies.

### BACKGROUND

In the fiber optic and telecommunications industry, customers require rapid assembly and delivery of products at low price points. Additionally, there is a desire to reduce shipping costs and carbon footprint.

Accordingly, improved fiber optic cable assemblies and assembly processes which address one or more of the above-recognized issues would be advantageous and desired in the art.

### BRIEF DESCRIPTION

Aspects and advantages of the invention in accordance with the present disclosure will be set forth in part in the following description, or may be obvious from the description, or may be learned through practice of the technology.

An aspect of the present disclosure is directed to a method for constructing an adaptive cable assembly. The method includes mass fusion splicing optical fibers at a cable with optical fibers at a connectorized fiber optic tail assembly, and positioning the mass fusion splice in a cavity extending along a longitudinal axis formed by a body extending along the longitudinal axis. The body forms a first open end along the longitudinal axis through which the connectorized fiber optic tail assembly is extended when the mass fusion splice is positioned in the cavity. The body forms a second open end along the longitudinal axis through which the fiber optic cable is extended when the mass fusion splice is positioned in the cavity.

Another aspect of the present disclosure is directed to a cable assembly including a body extending along a longitudinal axis. The body forms a first open end and a second open end along the longitudinal axis. The first open end forms a substantially rectangular cross sectional area and the second open end forming a substantially circular cross sectional area. The body forms a cavity extending along the longitudinal axis. An attachment interface is positioned at the second open end, the attachment interface forming a raised wall or clip configured to receive a boot.

These and other features, aspects and advantages of the present invention will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present subject matter, including the best mode thereof, directed to one of ordinary skill in the art, is set forth in the specification, which makes reference to the appended figures, in which:

FIG. 1 provides a perspective view of an embodiment of an adaptive cable assembly in accordance with aspects of the present disclosure;

FIG. 2 provides a perspective view of an embodiment of a body of the adaptive cable assembly of FIG. 1 in accordance with aspects of the present disclosure;

FIG. 3 provides a perspective exploded view of components of an embodiment of the adaptive cable assembly of FIG. 1 in accordance with aspects of the present disclosure;

FIG. 4 provides a side cross sectional view of an embodiment of the adaptive cable assembly of FIG. 1 in accordance with aspects of the present disclosure;

FIG. 5 provides a perspective view of an embodiment of an adaptive cable assembly in accordance with aspects of the present disclosure;

FIG. 6 provides a perspective exploded view of an embodiment of the adaptive cable assembly of FIG. 5 in accordance with aspects of the present disclosure;

FIG. 7 provides a perspective view of an embodiment of a body of the adaptive cable assembly of FIG. 5 in accordance with aspects of the present disclosure;

FIG. 8 provides a side cross sectional view of an embodiment of the body of the adaptive cable assembly of FIG. 5 in accordance with aspects of the present disclosure;

FIG. 9 provides a side cross sectional view along a first dimension of an embodiment of the adaptive cable assembly of FIG. 5 in accordance with aspects of the present disclosure;

FIG. 10 provides a side cross sectional view along a second dimension of an embodiment of the adaptive cable assembly of FIG. 5 in accordance with aspects of the present disclosure;

FIG. 11 provides a perspective view of an embodiment of an adaptive cable assembly in accordance with aspects of the present disclosure;

FIG. 12 provides a perspective exploded view of an embodiment of the adaptive cable assembly of FIG. 11 in accordance with aspects of the present disclosure;

FIG. 13 provides a perspective view of an embodiment of a body of the adaptive cable assembly of FIG. 11 in accordance with aspects of the present disclosure;

FIG. 14 provides a side cross sectional view along a first dimension of an embodiment of the adaptive cable assembly of FIG. 11 in accordance with aspects of the present disclosure;

FIG. 15 provides a side cross sectional view along a second dimension of an embodiment of the adaptive cable assembly of FIG. 11 in accordance with aspects of the present disclosure;

FIG. 16 provides a perspective view of an embodiment of an adaptive cable assembly in accordance with aspects of the present disclosure;

FIG. 17 provides a perspective view of an embodiment of a body of the adaptive cable assembly of FIG. 16 in accordance with aspects of the present disclosure;

FIG. 18 provides a side cross sectional view along a first dimension of an embodiment of the adaptive cable assembly of FIG. 16 in accordance with aspects of the present disclosure;

FIG. 19 provides a side cross sectional view along a second dimension of an embodiment of the adaptive cable assembly of FIG. 16 in accordance with aspects of the present disclosure;

FIG. 20 provides a perspective view of an embodiment of an adaptive cable assembly in accordance with aspects of the present disclosure;

FIG. 21 provides a perspective exploded view of an embodiment of the adaptive cable assembly of FIG. 20 in accordance with aspects of the present disclosure;

FIG. 22 provides a perspective view of an embodiment of a body of the adaptive cable assembly of FIG. 20 in accordance with aspects of the present disclosure;

FIG. 23 provides a side cross sectional view of an embodiment of the adaptive cable assembly of FIG. 20 in accordance with aspects of the present disclosure;

FIG. 24 provides a flowchart outlining exemplary steps of a method for construction of an adaptive cable assembly;

FIG. 25 provides a perspective view of an exemplary embodiment of a splice apparatus including an embodiment of the adaptive cable assembly in accordance with aspects of the present disclosure;

FIG. 26. provides a plan view of an exemplary embodiment of a splice apparatus including an embodiment of the adaptive cable assembly in accordance with aspects of the present disclosure;

FIG. 27 provides a plan view of an exemplary embodiment of a splice apparatus including an embodiment of the adaptive cable assembly in accordance with aspects of the present disclosure;

FIG. 28 provides an embodiment of steps of a method for construction of an adaptive cable assembly in accordance with aspects of the present disclosure;

FIG. 29 provides an embodiment of steps of a method for construction of an adaptive cable assembly in accordance with aspects of the present disclosure;

FIG. 30 provides an embodiment of steps of a method for construction of an adaptive cable assembly in accordance with aspects of the present disclosure.

Repeat use of reference characters in the present specification and drawings is intended to represent the same or analogous features or elements of the present invention.

### DETAILED DESCRIPTION

Reference now will be made in detail to embodiments of the present invention, one or more examples of which are illustrated in the drawings. The word “exemplary” is used herein to mean “serving as an example, instance, or illustration.” Any implementation described herein as “exemplary” is not necessarily to be construed as preferred or advantageous over other implementations. Moreover, each example is provided by way of explanation, rather than limitation of, the technology. In fact, it will be apparent to those skilled in the art that modifications and variations can be made in the present technology without departing from the scope or spirit of the claimed technology. For instance, features illustrated or described as part of one embodiment can be used with another embodiment to yield a still further embodiment. Thus, it is intended that the present disclosure covers such modifications and variations as come within the scope of the appended claims and their equivalents. The detailed description uses numerical and letter designations to refer to features in the drawings. Like or similar designations in the drawings and description have been used to refer to like or similar parts of the invention.

As used herein, the terms “first”, “second”, and “third” may be used interchangeably to distinguish one component from another and are not intended to signify location or importance of the individual components. The singular forms “a,” “an,” and “the” include plural references unless the context clearly dictates otherwise. The terms “coupled,” “fixed,” “attached to,” and the like refer to both direct coupling, fixing, or attaching, as well as indirect coupling, fixing, or attaching through one or more intermediate components or features, unless otherwise specified herein. As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive—or and not to an exclusive—or. For example, a condition A or B is satisfied by any one of the following: A is true (or present) and B is false (or not present), A is false (or not present) and B is true (or present), and both A and B are true (or present).

Ranges provided herein are inclusive of their end points. For instance, a range of 1 to 100 includes 1 and 100.

Terms of approximation, such as “about,” “generally,” “approximately,” or “substantially,” include values within a ten percent full scale error from a lowest value embodiment to a highest value embodiment. For instance, an embodiment including a range from approximately 10 to approximately 100 with a ten percent full scale error may include values from 1 to 109.

Benefits, other advantages, and solutions to problems are described below with regard to specific embodiments. However, the benefits, advantages, solutions to problems, and any feature(s) that may cause any benefit, advantage, or solution to occur or become more pronounced are not to be construed as a critical, required, or essential feature of any or all the claims.

Embodiments of a cable assembly and method for constructing or assembling a cable assembly are provided. Embodiments provided herein may provide rapid and low-labor assembly of moderate-to-high fiber count cable assemblies. Additionally, or alternatively, embodiments provided herein may allow for high-volume production of components that can be stocked and available on-demand for constructing high-count or complex terminated cable assemblies on-demand, onsite, at the point-of-installation, or allow for repair and reconfiguration of existing cables.

Referring now to the drawings, embodiments of an adaptive cable assembly 100 are provided in accordance with aspects of the present disclosure. The cable assembly 100 includes a body 110 extending along a longitudinal axis 11. The body 110 forms open ends through which a cable 101, 102 is extendable through the body 110 along the longitudinal axis 11 between a first end 103 and a second end 104. The first end 103 forms an end through which a plurality of fibers extends from the body 110, such as depicted at fiber optic tail 101. The fiber optic tail 101 may be configured as fiber optic furcation tails including single or multiple fibers per tube or tail, or as fiber optic furcation ribbon tails (e.g., ribbonized), or as pre-terminated fiber optic tails, etc. The fiber optic tail 101 may include any appropriate fiber optic connector (e.g., connector 105 depicted in FIGS. 29-30), such as but not limited to, ST, LC, SC, MT, MPO, MPT, etc. connectors.

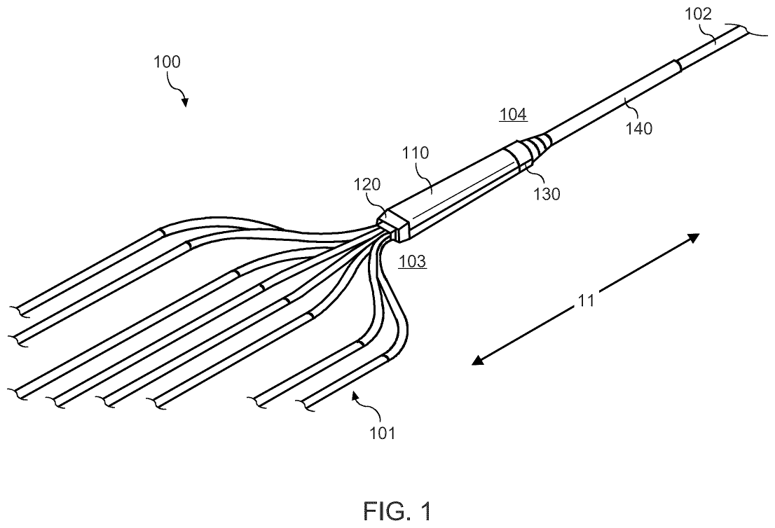

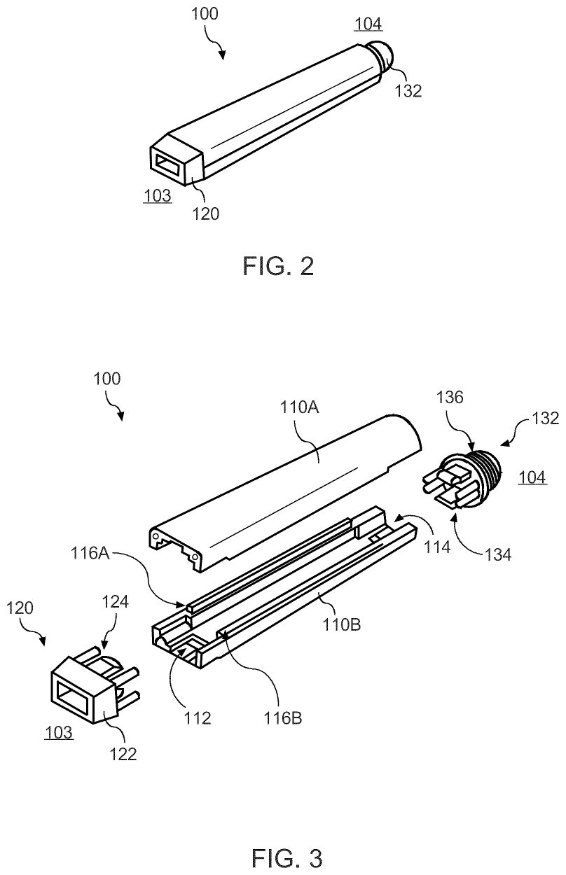

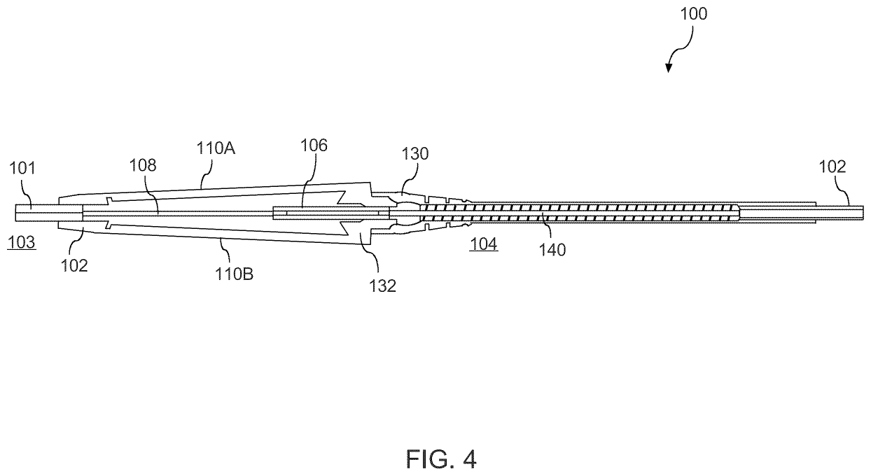

Referring to FIGS. 1-4, in various embodiments, the assembly 100 includes the body 110 including split portions, halves, or longitudinally extended sidewalls, such as portions 110A, 110B of the body. The portions 110A, 110B may include alignment and retention features, such as a protrusion 116A configured to insert, mate, or be received at a recess 116B at pairs of body 110A, 110B. In some embodiments, retention features 116A, 116B may extend along the longitudinal axis 11, such as along a substantial length of the body 110 between the open ends 103, 104. In other embodiments, retention feature 116A may form pegs, shafts, or walls extending co-directional to the retention feature 116B forming a recess, hole, slot, or groove into the body 110. In some embodiments, portions 110A, 110B are configured substantially symmetrical to one another. For instance, retention feature 116A may extend substantially co-directional to retention feature 116B, such as to allow each portion 110A to substantially mirror one another. Accordingly, body 110 may include a pair of portions 110A configured to mate into one another to form cavity 118 therebetween.

The cavity 118 is formed in the body 110 extending along the longitudinal axis 11. In various embodiments, the body 110 may form the cavity 118 having a flared, divergent, or increasing cross-sectional area at the first end 103 relative to second end 104 or areas therebetween. In some embodiments, the first end 103 at the body 110 forms a substantially rectangular cross sectional opening 112. The first end 103 is configured to receive a first end cap 120 including a first end cap body 122 and a mechanical retainer 124, such as a clip, configured to selectively attach to the body 110. The first end cap 120 may further form a substantially rectangular cross sectional opening corresponding to the first end 103, such as to allow the fiber optic tails 101 to extend therethrough.

In still some embodiments, the second end 104 at the body 110 forms a substantially circular, ovular, or elliptical cross sectional opening 114. The second end 104 is configured to receive a second end cap 132 including an attachment interface 136 for a cable sheath or boot 130. The attachment interface 136 may form a thread, raised walls, nipple, or other surface configured to receive the boot 130. The second end cap 132 may further include a mechanical retainer 134, such as a clip, configured to selectively attach to the body 110 at the second end 104. Mechanical retainers 124, 134 may form any appropriate fit, such as press fit, snap fit, allowing a user to selectively and releasably attach the cap 120, 132 to the body 110.

An exemplary embodiment of a method for constructing an adaptive cable assembly allows for single mass fusion splicing and all-mechanical retention (e.g., free of resins, epoxies, sealants, etc.), or substantially all-mechanical retention, of components to a cable. For instance, the method may include extending a fiber optic tail assembly (e.g., fibers 101) including a plurality of optical fiber tails through the first end cap 120. The method may include connecting terminal ends of the tails 101 to a fiber optic connector (e.g., connector 105 depicted in FIGS. 29-30). Each tail may include one or more optical fibers housed in a buffer tube. The method includes splicing optical fibers from a cable 102 with optical fibers from the tail assembly 101. The method may include coupling an encapsulating material 106 at a splice point of the cable 102 to the tails 101. For instance, the encapsulating material 106 including a splice protector and spliced leads 108 are placed at the cavity 118 inside the body 110. For instance, body portions 110A, 110B are pressed, snapped, clipped, or otherwise mated together to position the spliced leads 108 in the cavity 118. The spliced leads 108 may include a splice protector surrounding the splice point between leads 108A, 108B. Additionally, or alternatively, the spliced leads 108 may be positioned in the cavity 118 and an encapsulating material (e.g., resin) may be provided through an opening 126 at the body 110. The method may include coupling the boot 130 to the cable 102 at the second end 104 and coupling the front end cap 120 at the first end 103. In some embodiments, a protective sheath 140 is coupled to the boot 130 and extended over a portion of the cable 102.

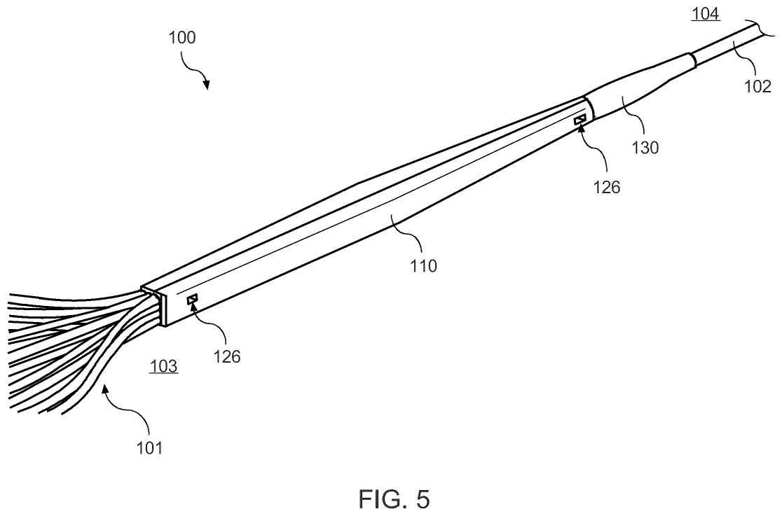

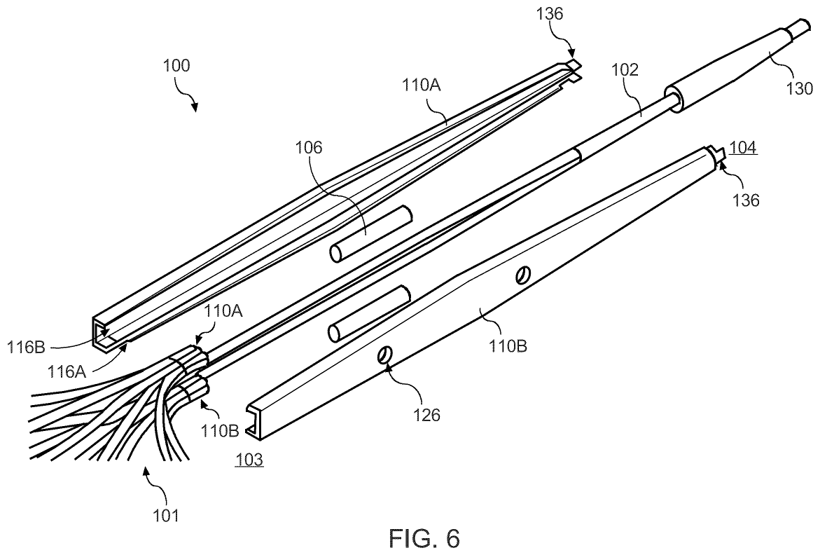

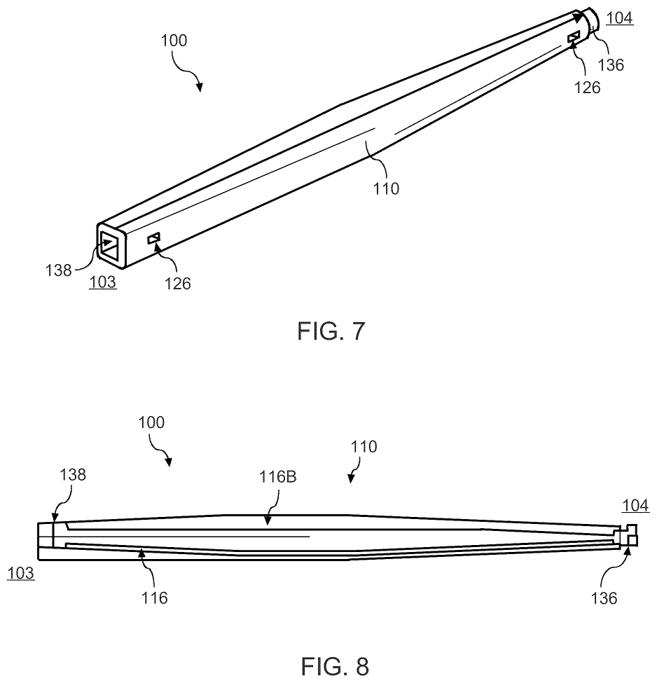

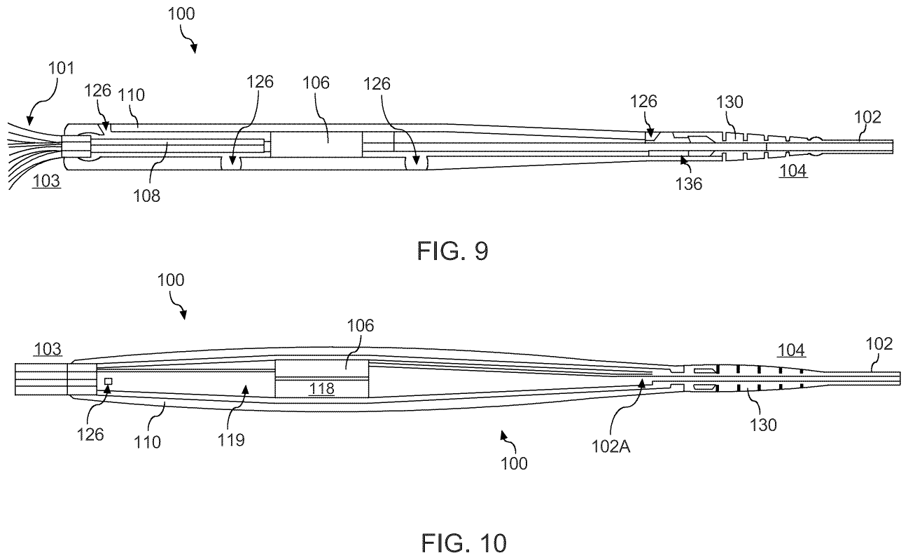

Referring now to FIGS. 5-10, in various embodiments, the assembly 100 includes the body 110 including split portions or halves, such as body 110A, 110B, and retention features 116A, 116B, such as described in regard to FIGS. 1-4. The body 110 may include a converging-diverging cross-sectional area in which an intermediate section 119 of the cavity 118 forms a greater cross-sectional area than one or both of the ends 103, 104. In various embodiments, the intermediate section 119 of the cavity 118 is approximately 35% to approximately 65% of a longitudinal distance extending from ends 103, 104 (e.g., an approximately 35%-65% span of the longitudinal distance between ends 103, 104).

The body 110 may include an attachment interface 136 forming a clip, retainer, tab, or other mechanical retention device at the second end 104. The attachment interface 136 may be formed as an integral portion of the body 110, such as at each body portion 110A, 110B at the second end 104. The body 110 may include openings 126 extending from a side wall of the body from an exterior to the cavity 118 to allow a sealant or resin to flow into the cavity 118. The body 110 may include a retention member 138 at the first end 103. The retention member 138 may form teeth, prongs, pegs, or other members extending from an inner wall of the body 110 and into the cavity 118. The retention member 138 is configured to contact the tails 101, such as to promote adhesion of the tails 101 to the body 110. The retention member 138 may be formed as an integral portion of the body 110, such as at each body portion 110A, 110B at the first end 103.

An exemplary embodiment of a method for constructing an adaptive cable assembly allows for fiber optic tail assembly with resin fill. Embodiments of the method may include muti-fiber optical tails such as described above. Fiber optic tails 101 may include one or more optical fibers, strength members (e.g., aramid yarn or other appropriate material), and a surrounding outer jacket. Two or more tails 101 may be bonded or adhered together to form tail sub-assemblies 101A, 101B. For instance, tail sub-assemblies 101A, 101B may include individual fiber optic tails bound together in grounds of three (3), or six (6), or nine (9), or twelve (12), etc. tails, such as to improve handling of multiple splices. Tail sub-assemblies 101A, 101B may include duplex tail units of approximately 1.6 millimeters (mm) or less.

Embodiments of the method may include splicing optical fibers from cable 102 with optical fibers at tails 101. In some embodiments, the method may include mass fusion splicing of fibers at the tail assembly 110 to corresponding fibers at the cable 102. The method may include coupling the encapsulating material 106 to the spliced leads 108. In some embodiments, the method includes coupling a resin, a splice protector, a sheath, or other material per quantity of fibers joined in a common fusion (e.g., per bundle of tails 101A, 101B). The spliced leads 108, encapsulating material 106, and cable 102 are positioned at the body 110. For instance, the spliced leads 108, encapsulating material 106, and cable 102 may be positioned at portion 101A. Portion 101B may be joined to portion 101A, such as retention features 116A, 116B, such that body 110 surrounds the spliced leads 108, encapsulating material 106, and end of cable 102 and tail 101 (e.g., tails 101A, 101B, etc.). Embodiments of the method include coupling boot 130 over the second end 104 of the body 110 (e.g., the second end 104 of the joined portions 110A, 110B). The method may include injecting, through openings 126, a sealant or resin (e.g., a two-part resin) to the cavity 118, such as to mechanically strengthen the assembly 100, secure the tails 101 and cable 102 to the body 110, and protect the spliced lead 108. The method may include positioning a portion of the cable 102, such as portion 102A having an aramid or cable jacket, into the cavity 118, such as to allow the resin to contact and affix to the portion of the cable 102 at the cavity 118 and form a strength member for the cable 102.

Embodiments of the method may allow for flexibility or customization of fiber counts through the body 110. Resin fill through the opening 126 may promote strengthening, improve cable retention at the body 110, and improve fiber and splice protection.

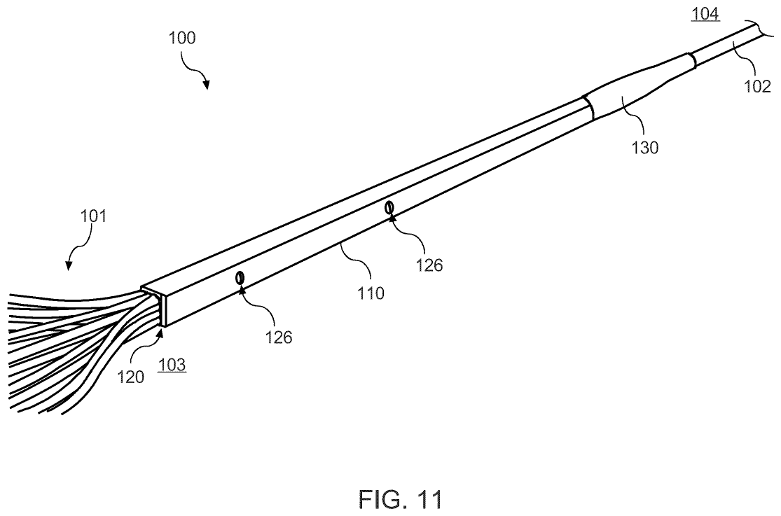

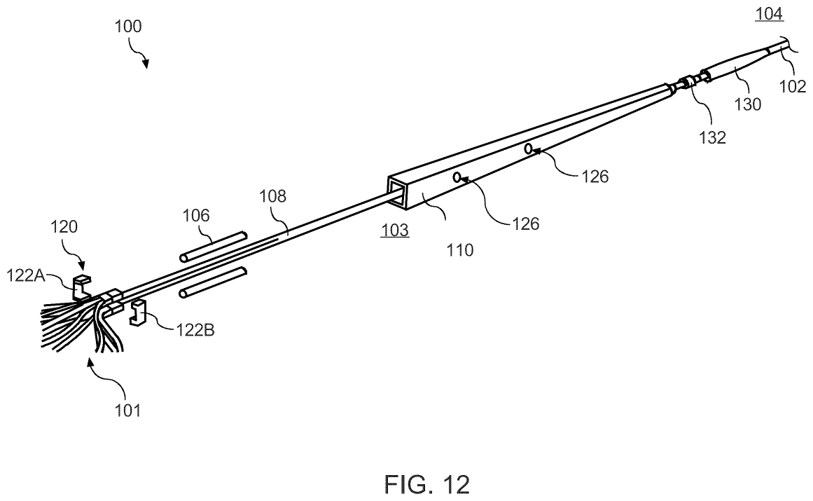

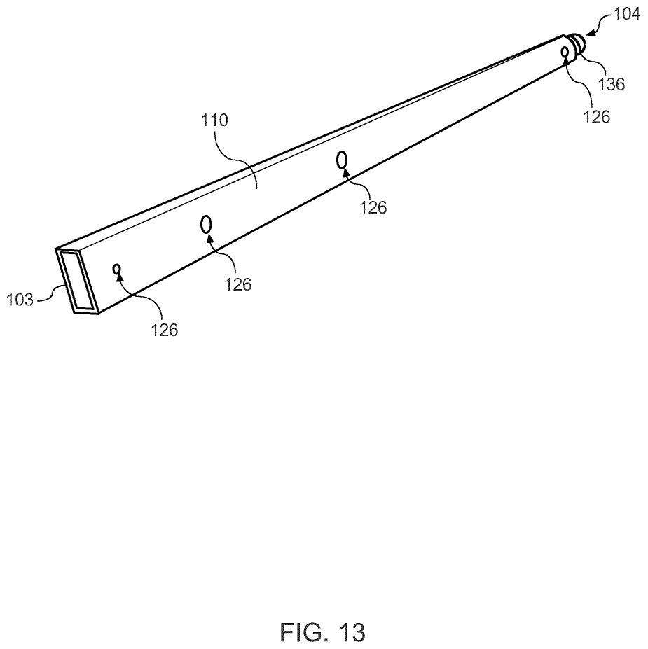

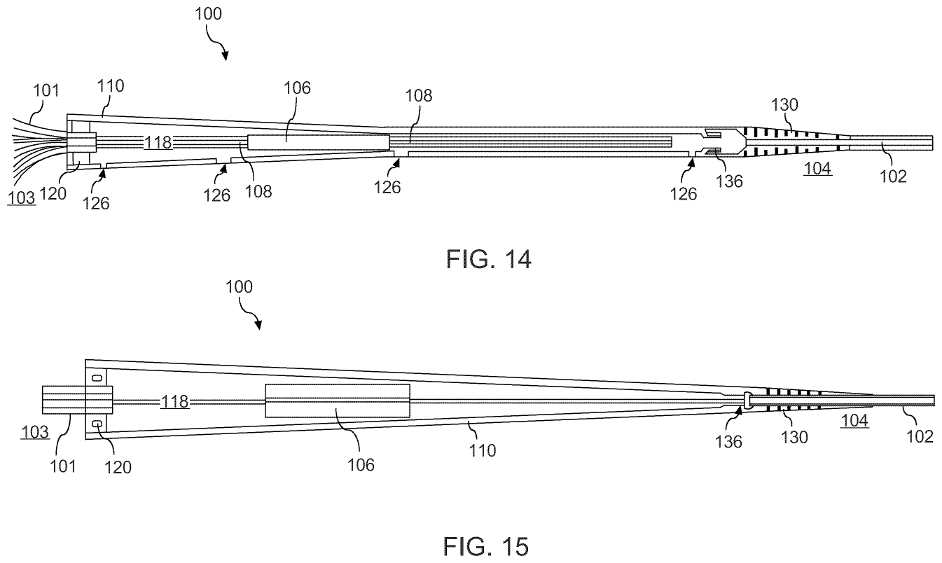

Referring now to FIGS. 11-15, in various embodiments, the assembly 100 includes the body 110, such as described in regard to FIGS. 1-10. The body 110 may include a diverging or increasing cross-sectional area in which the first end 103 forms a greater area of the cavity 118 than the second end 104. The body 110 may form a monolithic, unitary component. For instance, the body 110 may form a tubular component including a transitioning cross-section between the first end 103 (e.g., rectangular cross section) and the second end 104 (e.g., circular cross section). A first cross sectional area (e.g., along a first side, such as width) may extend along the length from the second end 104 to the first send 103, such as depicted in FIG. 15. A second cross sectional area (e.g., along a second side, such as height) may extend substantially constantly along the length from the second end 104 to the first end 103, such as depicted in FIG. 14. The assembly 100 may include the first end cap 120 including a split first end cap body 122 including portions 122A, 122B. The first end cap 120, such as portions 122A, 122B, allow the tails 101 to extend therethrough and snap, clip, contact, or otherwise attach around the tails 101.

An exemplary embodiment of a method for constructing an adaptive cable assembly allows for fiber optic tail assembly with resin fill and the tail assembly 101 to be spliced onto the end of the cable 102. As described herein, the tail assembly 101 may include a plurality of tail sub-assemblies (e.g., tails 101A, 101B, etc.), allowing for total fiber count to be adapted or customized. For instance, the tail assembly 101 may include one or more optical fibers, strength members (e.g., aramid yarn or other appropriate material), and a surrounding outer jacket, with two or more tails 101A, 101B bonded together to form tail sub-assemblies. Terminal ends of the tails 101 may include optical fiber connectors such as described herein. The method may include splicing optical fibers from the tail assembly 101 at the first end 103 to the cable 102 at the second end 104. For instance, the method may include mass fusion splicing of the fibers at the tail assembly 101 to corresponding fibers at the cable 102. Encapsulating material 106 may be provided at the spliced leads 108. For instance, a splice protector may be provided for each set of fibers (e.g., 101A, 101B) that are joined in a common fusion process. The joined assembly including the tail assembly 101 and cable 102 is positioned in the body 110 (e.g., at the cavity 118). The method includes positioning the boot 130 at the at the body 110. In one embodiment, the boot 130 is provided around the second end cap 132 and the second end cap 132 is coupled to the body 110 at the second end 104. In some embodiments, the method includes injecting or otherwise disposing a resin through openings 126 at the body 110, such as to strength the assembly mechanically, to secure the tails and cable together, or to protect the spliced leads 108.

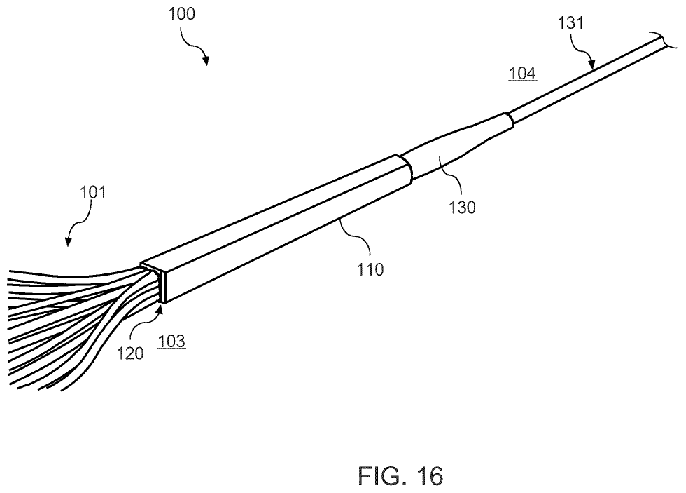

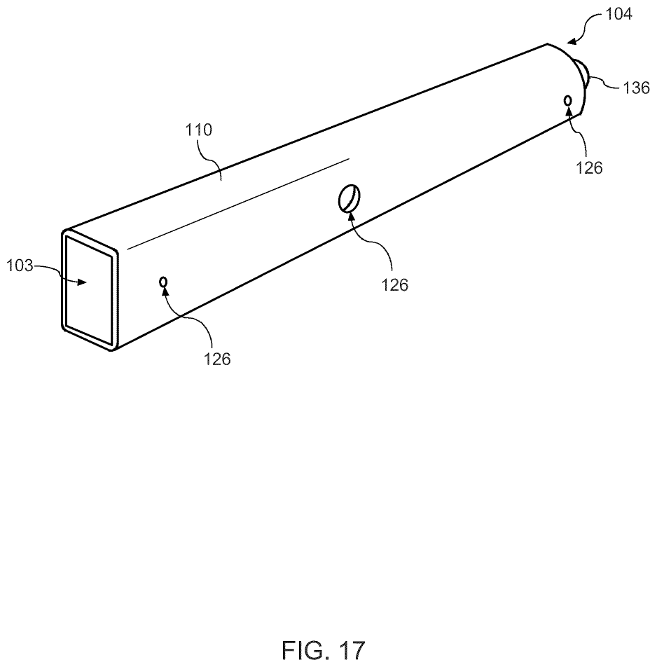

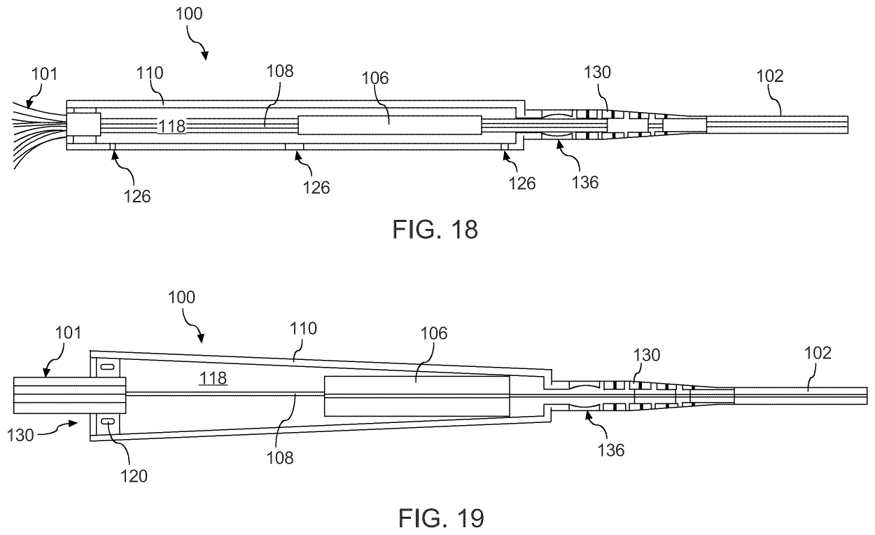

Referring now to FIGS. 16-19, in various embodiments, the assembly 100 includes the body 110, such as described in regard to FIGS. 11-15. The body 110 may further include an attachment interface 136 forming a thread, raised walls, nipple, or other surface configured to receive the boot 130. The attachment interface 136 may formed integrally to the body 110, such as to form the body 110 as a monolithic, unitary component.

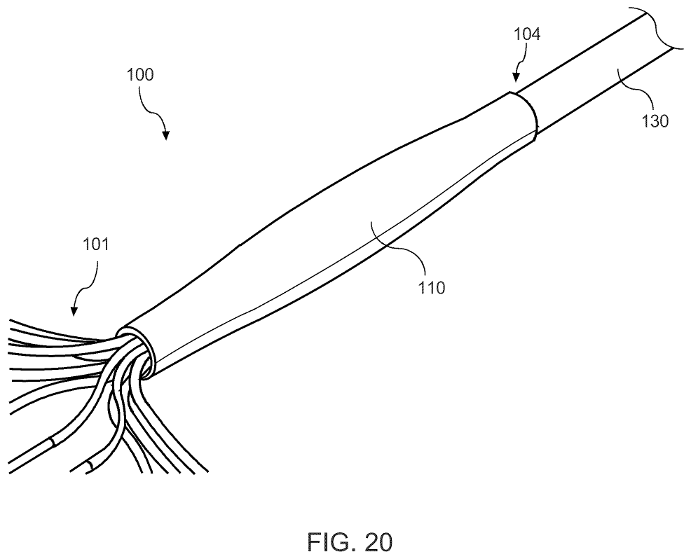

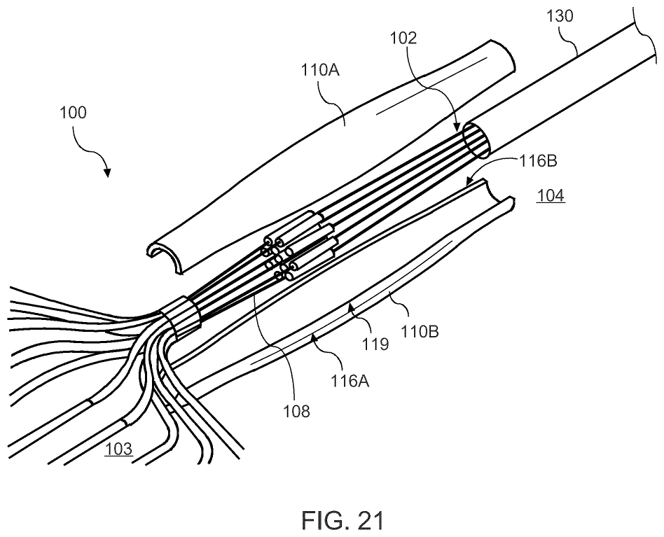

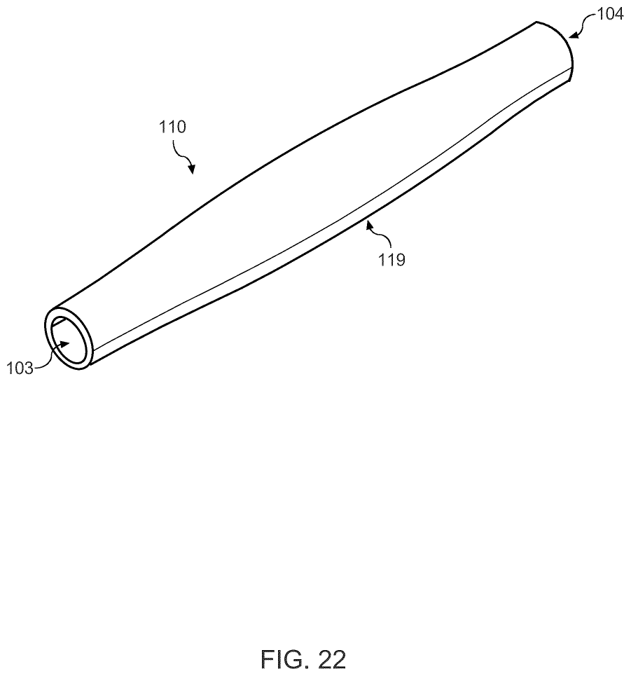

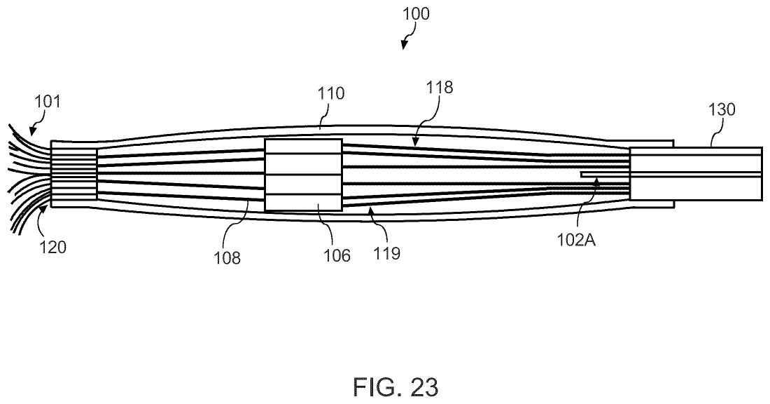

Referring now to FIGS. 20-23, in various embodiments, the assembly 100 includes the body 110, such as described in regard to FIGS. 1-10. The body 110 may form a split body having portions 110A, 110B, such as described herein. The body 110 may form a substantially circular cross section extending from the first end 103 to the second end 104. The cross sectional area may form a converging-diverging cross sectional area including a greatest area at the intermediate section 119. The larger cavity 118 (e.g., the substantially circular cross sectional area, the increased intermediate section area, or both) may allow for greater fiber core counts (e.g., 24 fibers or greater, such as, but not limited to, 72, 96, 144, 288, or 576, etc.).

An exemplary embodiment of a method for constructing an adaptive cable assembly includes steps such as described above. Furthermore, the cable jacket and strength member at portion 102A may further extend through the second end 104 and into a resin-filled cavity 118, such as to provide mechanical fixing such as described above.

Various embodiments of a method for constructing an adaptive cable assembly may allow for connectorized tails 101 to be assembled at a first location (e.g., at a first facility) and assembled to a main fiber optic cable 102 at a second location (e.g., at a point installation). Embodiments of the method may include terminating a multi-fiber cable assembly (e.g., tails 101). Terminating the multi-fiber cable assembly may include mass ribbon splicing of at least six (6) fibers per splice. The method may include mass fusion splicing one or more multi-tail assemblies (e.g., tail assemblies 101A, 101B) to fibers at fiber optic cable (e.g., cable 102). In some embodiments, mass splicing includes splicing tails to rollable, flexible, ribbon fibers, or discrete, loose fibers, at a high fiber count cable (e.g., cable 102).

In certain embodiments, the method includes splicing at least 12-fiber tails, or subunits thereof, using two millimeter diameter round cable/furcation with aramid strength members.

In still certain embodiments, the method includes splicing at least 24-fiber tails, or subunits thereof, using three millimeter diameter round cable/furcation with aramid strength members.

The body 110 may include a length along the longitudinal direction between approximately 60 millimeters and approximately 200 millimeters (mm). For instance, embodiments described in regard to FIGS. 1-4 may include the body 110 having a length between approximately 60 mm and approximately 80 mm, or approximately 65 mm. For instance, embodiments described in regard to FIGS. 5-10 may include the body 110 having a length between approximately 155 mm and approximately 185 mm, or approximately 170 mm. In another instance, embodiments described in regard to FIGS. 11-15 may include the body 110 having a length between approximately 170 mm and approximately 200 mm, or approximately 185 mm. For instance, embodiments described in regard to FIGS. 16-19 may include the body 110 having a length between approximately 85 mm and approximately 115 mm, or approximately 100 mm. In yet another instance, embodiments described in regard to FIGS. 20-23 may include the body 110 having a length between approximately 185 mm and approximately 200 mm.

The body 110 may include a maximum cross sectional area within the body 110 (e.g., at cavity 118) between approximately 108 square mm (mm²) and approximately 616 mm² . For instance, the maximum cross sectional area may be at the intermediate section 119, such as described regarding converging-diverging cross sectional areas. In some embodiments, the maximum cross sectional area is positioned at the intermediate section 119 and includes a substantially circular cross sectional area. In various embodiments, such as described in regard to FIGS. 20-23, the maximum cross sectional area is up to approximately 616 mm². In another instance, the maximum cross sectional area may be at the first end 103, such as described in regard to FIGS. 1-4 or FIGS. 11-19. The maximum cross sectional area at the first end 103 may be between approximately 108 mm² and approximately 216 mm². The maximum cross sectional area at the first end 103 may be a substantially rectangular cross sectional area. In some embodiments, the maximum cross sectional area at the first end 103 including the substantially rectangular cross sectional area may include a first dimension (e.g., height) greater than a second dimension (e.g., width). The second dimension may be between approximately 60% to approximately 75% of the first dimension.

In various embodiments, a minimum cross sectional area may be positioned at the second end 104. For instance, the minimum cross sectional area may be formed to include an approximately 9 mm² opening to receive a connector/aramid crimp, such as to fix the strength member at cable 102 to the rear of the cable breakout or hold the rear of the cable 102 together.

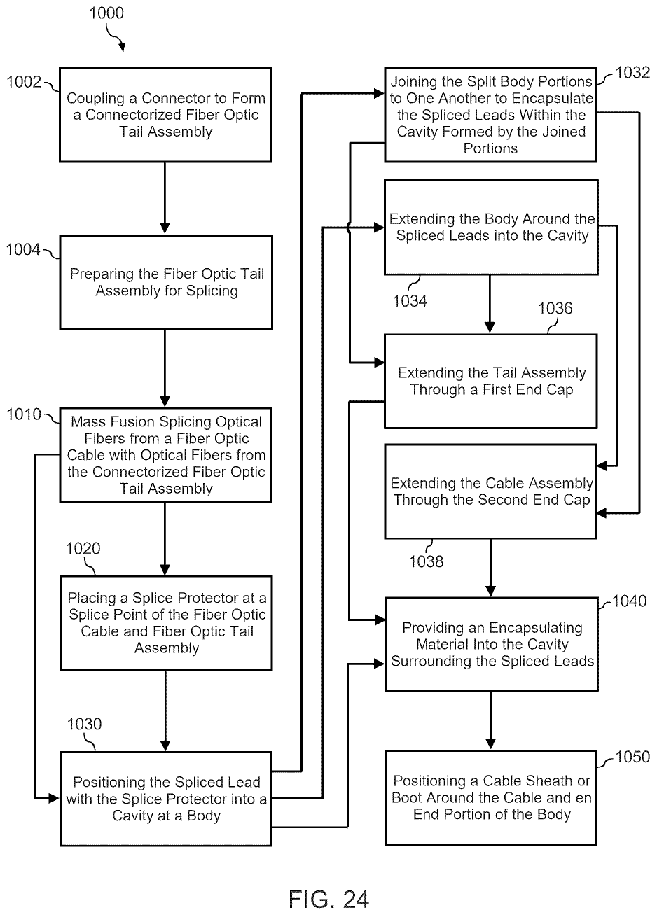

Referring now to FIG. 24, a flowchart outlining exemplary steps of a method for construction of an adaptive cable assembly is provided (hereinafter, “method 1000”). Steps of the method 1000 may include forming structures, couplings, splices, or connections such as described in regard to the adaptive cable assembly 100 in FIGS. 1-23. However, it should be appreciated that steps of the method 1000 may include other structures and steps for fiber optic cable assembly, such as provided herein.

Method 1000 includes at 1002 coupling a connector (e.g., one or more connectors) to form a connectorized fiber optic tail assembly. In various embodiments, step 1002 may occur at low-cost manufacturing locations (e.g., a first assembly location) relative to other steps of the method 1000. Tail assemblies (e.g., tail assembly 101) may be produced in high volume and relatively low cost at the first assembly location.

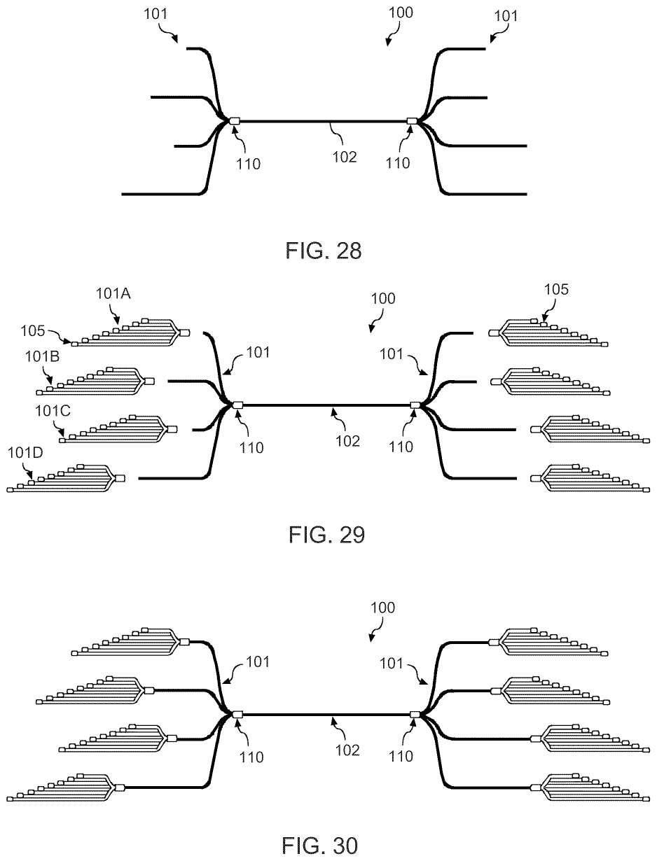

Embodiments of method 1000 may include at 1004 preparing the fiber optic tail assembly for splicing. Method 1000 at 1004 may include cutting the tail assembly to a predetermined length, positioning fibers into a fiber holder, or cleaving fibers. For instance, FIG. 28 depicts an embodiment of the assembly 100 without connectors installed. FIG. 29 depicts an embodiment of the assembly 100 at which method 1000 at step 1002 couples a connector 105 to ends of the fiber optic tail assembly 101. The fiber optic tail assembly 101 may include a plurality of tail sub-assemblies 101A, 101B, 101C, 101D, etc. FIG. 30 depicts an embodiment of the assembly 100 including the fiber optic tails 101 operably coupled with connectors 105. Embodiments of the method 1000 at step 1004 may be performed at a second assembly location different from the first assembly location.

Method 1000 includes at 1010 mass fusion splicing optical fibers from a fiber optic cable (e.g., cable 102) with optical fibers from the connectorized fiber optic tail assembly (e.g., tail assembly 101), such as described in various embodiments herein. Method 1000 at 1010 forms a mass fusion splice at the cable assembly. In various embodiments, method 1000 at 1010 includes mass fusion splicing optical fibers from the fiber optic cable with optical fibers from the fiber optic tail assembly at a second assembly location. The second location may include an inside plant (ISP) location or an outside plant (OSP) location, such as a point of installation, a point of repair, or point of reconfiguration. In some embodiments, splicing optical fibers may include mass ribbon splicing of at least six (6) fibers per splice.

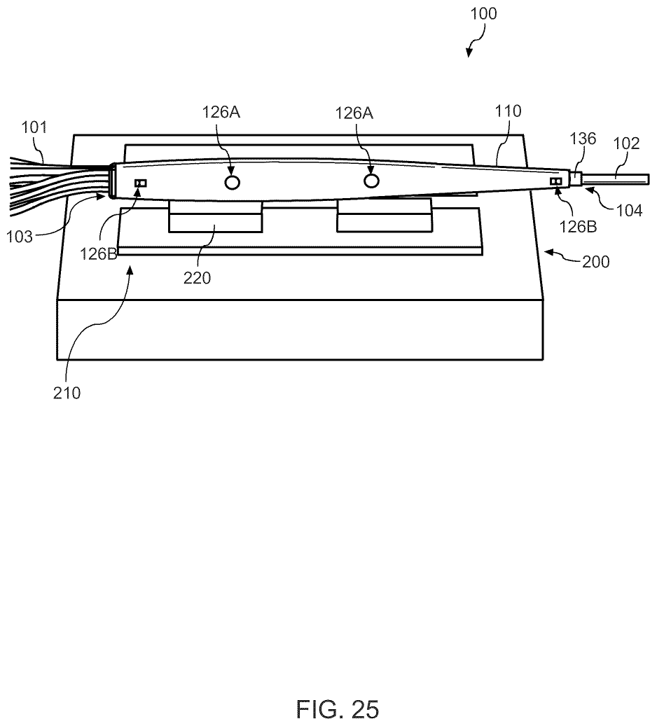

In various embodiments, the tail assembly is constructed at a first location (e.g., step 1002) and the mass fusion splicing is performed at a second location (e.g., step 1010) different from the first location. Splice preparation may occur at the second location prior to performing the mass splice. For instance, referring to FIGS. 25-27, method 1000 at 1004 may utilize a splice apparatus 200 to perform steps of method 1000. In various embodiments, the method 1000 may include positioning fiber leads from the tail assembly (e.g., fiber leads 108A from tail assembly 101) and the cable (e.g., fiber leads 108B from cable 102) into a splice apparatus (e.g., splice apparatus 200). Exemplary embodiments of the splice apparatus 200 may include a splice tool 210 including one or more clamps 220. The splice tool 210 may further include positioning ribs, clamps, channels, or other members to desirably position, place, or retain fibers in a fixed position. The splice tool 210 may be configured to perform fusion splicing, mass fusion splicing, or other splice methods as may be understood in the art.

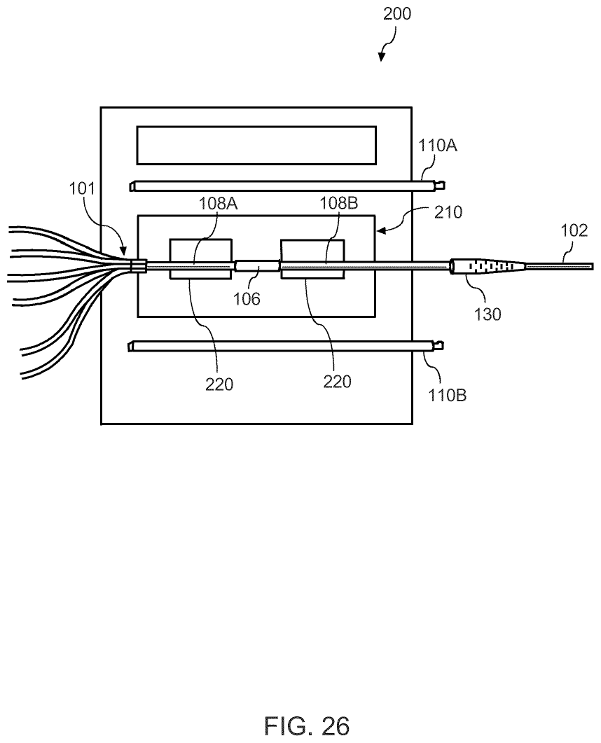

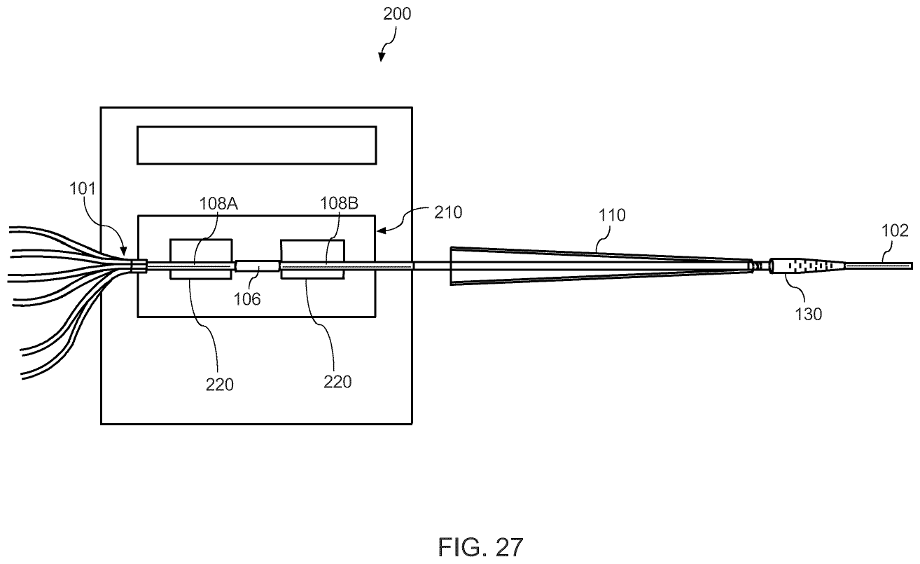

In some embodiments, method 1000 includes at 1020 placing a splice protector at a splice point (e.g., at the mass fusion splice) of the fiber optic cable and fiber optic tail assembly (e.g., spliced leads 108A, 108B). In various embodiments, the encapsulating material may include a resin, a splice protector, resin, or combinations thereof). In some embodiments, method 1000 at 1020 includes positioning a splice protector at a splice point at the spliced leads (e.g., the mass fusion splice), such as depicted at encapsulating material 106 at spliced leads 108A, 108B in FIGS. 26-27.

Method 1000 includes at 1030 positioning the spliced lead with the splice protector, such as the mass fusion splice, into a cavity at a body (e.g., cavity 118 at body 110). For instance, referring to FIGS. 25-26, embodiments of the body 110 are configured as a split body including portions 110A, 110B separated from another along a longitudinal axis (e.g., co-directional to extension of the fibers). Method 1000 may include at 1032 joining the split body portions to one another to encapsulate the spliced leads (e.g., spliced leads 108A, 108B) within the cavity (e.g., cavity 118) formed by the joined portions (e.g., portions 110A, 110B). For instance, portions 110A, 110B may be snapped, bound, or otherwise adhered to one another such as described in regard to FIGS. 1-10 and FIGS. 20-23.

In still some embodiments, method 1000 may include at 1034 extending the body around the spliced leads into the cavity. For instance, referring to FIGS. 11-19 and FIG. 27, embodiments of the body 110 are configured as a monolithic, unitary component. Body 110 is positioned adjacent to the splice apparatus 200 during splicing (e.g., step 1010). The body 110 slides co-directional to an extension of the fibers to position the spliced leads 108A, 108B within the cavity 118 in the body 110.

Method 1000 at 1030 may further include at 1036 extending the tail assembly through a first end cap (e.g., first end cap 120), and at 1038 extending the cable assembly through the second end cap, such as depicted and described in regard to FIGS. 1-10 and FIGS. 20-23.

Embodiments of the assembly 100 including the body 110 having portions 110A, 110B may allow for nearer positioning of the boot 130 to the splice apparatus 200, such as when performing step 1010, such as depicted in FIG. 26. For example, body 110 forming a unitary structure may be positioned adjacent to the splice apparatus 200, and boot 130 may be positioned adjacent to the body 110, such as depicted in FIG. 27. Accordingly, the split body may facilitate utilizing less length of cable 102 than the unitary body, such as may improve setup time and require less space for splicing.

Method 1000 may include at 1040 providing an encapsulating material (e.g., resin) into the cavity surrounding the spliced leads. For instance, resin may be injected through a first opening 126A positioned more proximate to an intermediate portion than a second opening 126B more proximate to open ends 103, 104. Method 1000 may include at 1040 providing the encapsulating material through one or more of opening 126A until the encapsulating material egresses from one or more of opening 126B.

Method 1000 may further include at 1050 positioning a cable sheath or boot around the cable and an end portion of the body. For instance, boot 130 may slide from around cable 102 toward the body 110 to circumscribe the attachment interface 136 at the end of the body 110. FIG. 30 depicts an embodiment of the assembly 100 including body 110, cable 102, and tail assembly 101 operably coupled to one another, such as in accordance with embodiments of method 1000.

Embodiments of the assembly 100 and method 1000 provided herein may include a split transition module, multiple mass splices in a single transition module, splice protection integrated into the transition module, cable and tail tensile load coupling, integral tail protection shroud, integral pulling feature(s), and processing of the splice lead and tail assembly. Embodiments of the assembly 100 and method 1000 may include combinations of maximum length or cross sectional area such as provided herein, such as to advantageously provide a structure and method allowing for splices, splice protection, and resin filling as described herein. Embodiments provided herein may allow for managed duplex polarity of tail assemblies (e.g., end A with alpha polarity and end B with beta polarity, or end A and end B with same polarity, or managed polarity of tails and both ends using polarity method F).

Embodiments of the assembly 100 and method 1000 provided herein may allow for rapid and low labor final assembly of moderate to high fiber count cable assemblies, and/or address one or more of the above-recognized issues. For instance, core elements of the assembly 100 may include pre-manufactured tail assemblies 101, sub-unitized or furcated cables 102, and mass splicing and transition closures. Labor-intensive tail assemblies 101 may be produced in high volume at lower cost relative to onsite (e.g., point of installation) splicing. High count terminated cable assemblies may be produced on-demand by splicing cut to length cable to the tail assemblies. In some embodiments, adaptive cable assemblies such as depicted and described herein, and methods for construction, may be used to make complex assemblies at the point of installation, to repair in-service cables, or to reconfigure installed cables.

In exemplary embodiments, total fiber counts may range from approximately 8 to approximately 576 fibers, or greater. In some embodiments, tail assemblies may include 8 to 24 fibers and include one to four mass fusion splice joints to connect an individual tail assembly to a cable or cable subunit. However, it should be appreciated that greater fiber counts may be included in embodiments of the assembly 100 and method 1000 described herein without deviating from the scope of the disclosure.

Further aspects of the invention are provided by one or more of the following embodiments:
1. A method for constructing an adaptive cable assembly, the method including mass fusion splicing optical fibers at a cable with optical fibers at a connectorized fiber optic tail assembly; and positioning the mass fusion splice in a cavity extending along a longitudinal axis formed by a body extending along the longitudinal axis, the body forming a first open end along the longitudinal axis through which the connectorized fiber optic tail assembly is extended when the mass fusion splice is positioned in the cavity, the body forming a second open end along the longitudinal axis through which the fiber optic cable is extended when the mass fusion splice is positioned in the cavity.
2. The method of any one or more clauses herein, wherein the tail assembly is constructed at a first location and the mass fusion splicing is performed at a second location different from the first location.
3. The method of any one or more clauses herein, the method including providing an encapsulating material into the cavity surrounding the mass fusion splice.
4. The method of any one or more clauses herein, wherein providing the encapsulating material includes injecting a resin through a first opening extending from a longitudinal sidewall of the body between the first and second open ends.
5. The method of any one or more clauses herein wherein providing the encapsulating material includes injecting the resin through the first opening until the resin egresses through a second opening proximate to one or both open ends.
6. The method of any one or more clauses herein, the body including longitudinal sidewalls separated along the longitudinal axis, wherein positioning the mass fusion splice in the cavity includes attaching the longitudinal sidewalls to one another to form the cavity and position the mass fusion splice therewithin.
7. The method of any one or more clauses herein, the method including coupling longitudinal sidewalls of the body together to position the mass fusion splice at the cavity.
8. The method of any one or more clauses herein, wherein coupling longitudinal sidewalls of the body together includes coupling retention features at respective longitudinal sidewalls to one another.
9. The method of any one or more clauses herein, wherein forming the mass fusion splice includes mass splicing fibers at least six fibers per splice.
10. The method of any one or more clauses herein, the method including placing a splice protector onto a splice point of the mass fusion splice before positioning the mass fusion splice in the cavity.
11. The method of any one or more clauses herein, the method including extending the fiber optic tail assembly through a first end cap; extending the fiber optic cable through a second end cap; and coupling the first end cap to the first open end at the body and coupling the second end cap to the second open end at the body after mass fusion splicing and positioning the mass fusion splice at the cavity.
12. The method of any one or more clauses herein, the body forming a unitary, monolithic longitudinal structure, wherein positioning the mass fusion splicing in the cavity includes sliding the body around the mass fusion splice to position the mass fusion splice within the cavity.
13. The method of any one or more clauses herein, wherein the connectorized fiber tail assembly includes approximately 8 fibers to approximately 576 fibers.
14. The method of any one or more clauses herein, wherein the fiber optic tail assembly includes a plurality of tail sub-assemblies.
15. The method of any one or more clauses herein, wherein mass fusion splicing optical fibers at the cable with optical fibers at the connectorized fiber optic tail assembly includes forming one or more mass fusion splice joints to connect the plurality of tail sub-assemblies to the fiber optic cable.
16. The method of any one or more clauses herein, wherein the method includes coupling halves of a split first end cap to one another and the plurality of tail sub-assemblies at the first open end.
17. The method of any one or more clauses herein, the method including positioning a boot around a second end cap at the body at the second open end; and coupling the boot to the fiber optic cable extending through the second open end.
18. A cable assembly, including a body extending along a longitudinal axis, the body forming a first open end and a second open end along the longitudinal axis, the first open end forming a substantially rectangular cross sectional area and the second open end forming a substantially circular cross sectional area, the body forming a cavity extending along the longitudinal axis, wherein an attachment interface is positioned at the second open end, the attachment interface forming a raised wall or clip configured to receive a boot.
19. The cable assembly of any one or more clauses herein, wherein the body includes separable longitudinal sidewalls extending along the longitudinal axis.
20. The cable assembly of any one or more clauses herein, the body forming a divergent cross sectional area at the cavity extending from the second open end to the first open end, wherein the first open end includes a maximum cross sectional area.
21. The cable assembly of any one or more clauses herein, wherein the maximum cross sectional area is between approximately 108 square millimeters and approximately 216 square millimeters.
22. The method of any one or more clauses herein, the method including forming the body extending along the longitudinal axis; forming a first open end at the body along the longitudinal axis; extending the connectorized fiber optic tail assembly through the first open end when the mass fusion splice is positioned in the cavity; forming a second open end at the body along the longitudinal axis; extending the fiber optic cable through the second open end when the mass fusion splice is positioned in the cavity.
23. A method for constructing the cable assembly of any one or more clauses herein, the method including mass fusion splicing optical fibers at the cable with optical fibers at the connectorized fiber optic tail assembly; and positioning the mass fusion splice in the cavity extending along the longitudinal axis formed by the body extending along the longitudinal axis.
24. A method for constructing the cable assembly of any one or more clauses herein, the method including forming the body extending along the longitudinal axis; forming a first open end at the body along the longitudinal axis; extending the connectorized fiber optic tail assembly through the first open end when the mass fusion splice is positioned in the cavity; forming a second open end at the body along the longitudinal axis; extending the fiber optic cable through the second open end when the mass fusion splice is positioned in the cavity.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method for constructing an adaptive cable assembly, the method comprising:
mass fusion splicing optical fibers at a cable with optical fibers at a connectorized fiber optic tail assembly;
positioning the mass fusion splice in a cavity extending along a longitudinal axis formed by a body extending along the longitudinal axis, the body forming a first open end along the longitudinal axis through which the connectorized fiber optic tail assembly is extended when the mass fusion splice is positioned in the cavity, the body forming a second open end along the longitudinal axis through which the fiber optic cable is extended when the mass fusion splice is positioned in the cavity.

2. The method of claim 1, wherein the tail assembly is constructed at a first location and the mass fusion splicing is performed at a second location different from the first location.

3. The method of claim 1, the method comprising:
providing an encapsulating material into the cavity surrounding the mass fusion splice.

4. The method of claim 3, wherein providing the encapsulating material comprises injecting a resin through a first opening extending from a longitudinal sidewall of the body between the first and second open ends.

5. The method of claim 4, wherein providing the encapsulating material comprises injecting the resin through the first opening until the resin egresses through a second opening proximate to one or both open ends.

6. The method of claim 1, the body comprising longitudinal sidewalls separated along the longitudinal axis, wherein positioning the mass fusion splice in the cavity comprises attaching the longitudinal sidewalls to one another to form the cavity and position the mass fusion splice therewithin.

7. The method of claim 1, the method comprising:
coupling longitudinal sidewalls of the body together to position the mass fusion splice at the cavity.

8. The method of claim 7, wherein coupling longitudinal sidewalls of the body together comprises coupling retention features at respective longitudinal sidewalls to one another.

9. The method of claim 1, wherein forming the mass fusion splice comprises mass splicing fibers at least six fibers per splice.

10. The method of claim 1, the method comprising:
placing a splice protector onto a splice point of the mass fusion splice before positioning the mass fusion splice in the cavity.

11. The method of claim 1, the method comprising:
extending the fiber optic tail assembly through a first end cap;
extending the fiber optic cable through a second end cap;
coupling the first end cap to the first open end at the body and coupling the second end cap to the second open end at the body after mass fusion splicing and positioning the mass fusion splice at the cavity.

12. The method of claim 1, the body forming a unitary, monolithic longitudinal structure, wherein positioning the mass fusion splice in the cavity comprises sliding the body around the mass fusion splice to position the mass fusion splice within the cavity.

13. The method of claim 1, wherein the connectorized fiber tail assembly comprises approximately 8 fibers to approximately 576 fibers.

14. The method of claim 1, wherein the fiber optic tail assembly comprises a plurality of tail sub-assemblies.

15. The method of claim 14, wherein mass fusion splicing optical fibers at the cable with optical fibers at the connectorized fiber optic tail assembly comprises forming one or more mass fusion splice joints to connect the plurality of tail sub-assemblies to the fiber optic cable.

16. The method of claim 14, wherein the method comprises coupling halves of a split first end cap to one another and the plurality of tail sub-assemblies at the first open end.

17. The method of claim 1, the method comprising:
positioning a boot around a second end cap at the body at the second open end; and
coupling the boot to the fiber optic cable extending through the second open end.

18. A cable assembly, comprising:
a body extending along a longitudinal axis, the body forming a first open end and a second open end along the longitudinal axis, the first open end forming a substantially rectangular cross sectional area and the second open end forming a substantially circular cross sectional area, the body forming a cavity extending along the longitudinal axis, wherein an attachment interface is positioned at the second open end, the attachment interface forming a raised wall or clip configured to receive a boot.

19. The cable assembly of claim 18, wherein the body comprises separable longitudinal sidewalls extending along the longitudinal axis.

20. The cable assembly of claim 19, the body forming a divergent cross sectional area at the cavity extending from the second open end to the first open end, wherein the first open end comprises a maximum cross sectional area, and wherein the maximum cross sectional area is between approximately 108 square millimeters and approximately 216 square millimeters.
